(19) United States
(12) Patent Application Publication
(10) Pub. No.: US 2025/0291305 A1
(43) Pub. Date: Sep. 18, 2025

(54) IMAGE FORMING APPARATUS

(71) Applicant: CANON KABUSHIKI KAISHA, Tokyo (JP)

(72) Inventors: TOMOOKU KOYAMA, Shizuoka (JP); HIDEKI OHTA, Shizuoka (JP); CHIKARA IMAIZUMI, Shizuoka (JP); RYO MIYATA, Kanagawa (JP); SEIJI OBATA, Shizuoka (JP); JIRO MORIYA, Shizuoka (JP)

(21) Appl. No.: 19/075,130

(22) Filed: Mar. 10, 2025

(30) Foreign Application Priority Data
Mar. 13, 2024 (JP) 2024-039390

(51) Int. Cl. G03G 21/16; G03G 15/00; G03G 15/20

(52) U.S. Cl. CPC G03G 21/1647; G03G 15/2017; G03G 15/2064; G03G 15/6552; G03G 21/1633; G03G 21/1652

(57) ABSTRACT

An image forming apparatus configured to form an image on a sheet includes an apparatus body, a mounting unit, a restricting portion configured to move to a restricting position and to an allowing position, a first connector, a second connector configured to move between a fitting position and a release position, and an interlocking portion configured to move between a first operation position and a second operation position and configured to be interlocked with the restricting portion and the second connector. The interlocking portion includes an operation portion, a pivot shaft configured to pivot integrally with the operation portion and configured to pivotably support the restricting portion, and a cam pivotably supported by the pivot shaft and configured to move the second connector from the fitting position to the release position.

### BACKGROUND OF THE INVENTION

### Field of the Invention

The present invention relates to an image forming apparatus that forms an image on a sheet.

### Description of the Related Art

JP 2020-71403 A proposes an image forming apparatus including a fixing unit that can be inserted into and removed from an apparatus body. A body side drawer connector is provided on the apparatus body, and a unit side drawer connector is provided on the fixing unit. When the fixing unit is inserted into the apparatus body, the unit side drawer connector of the fixing unit is fitted to the body side drawer connector of the apparatus body.

However, the body side drawer connector and the unit side drawer connector described in JP 2020-71403 A are configured to be fitted or separated simultaneously with the insertion and removal of the fixing unit when the fixing unit is inserted into and removed from the apparatus body. Therefore, when the fixing unit is removed from the apparatus body, a force for releasing the fitting between the body side drawer connector and the unit side drawer connector is required, and workability at the time of removing the fixing unit is deteriorated.

### SUMMARY OF THE INVENTION

According to a first aspect of the present invention, an image forming apparatus configured to form an image on a sheet includes an apparatus body, a mounting unit mounted on the apparatus body at a mounting position, a restricting portion configured to move to a restricting position where the restricting portion restricts a movement of the mounting unit from the mounting position, and to an allowing position where the restricting portion allows the movement of the mounting unit from the mounting position, a first connector provided in either one of the apparatus body and the mounting unit, a second connector provided in the other of the apparatus body and the mounting unit and configured to move between a fitting position where the second connector is fitted to the first connector to electrically connect the apparatus body to the mounting unit and a release position where fitting of the second connector to the first connector is released, and an interlocking portion configured to move between a first operation position and a second operation position and configured to be interlocked with the restricting portion and the second connector, the interlocking portion moving from the first operation position to the second operation position so that the restricting portion moves from the restricting position to the allowing position and the second connector moves from the fitting position to the release position. The interlocking portion includes an operation portion, a pivot shaft configured to pivot integrally with the operation portion and configured to pivotably support the restricting portion, and a cam pivotably supported by the pivot shaft and configured to move the second connector from the fitting position to the release position.

According to a second aspect of the present invention, an image forming apparatus configured to form an image on a sheet includes an apparatus body, a mounting unit mounted on the apparatus body at a mounting position, a restricting portion configured to move to a restricting position where the restricting portion restricts a movement of the mounting unit from the mounting position, and to an allowing position where the restricting portion allows the movement of the mounting unit from the mounting position, a first connector provided in either one of the apparatus body and the mounting unit, a second connector provided in the other of the apparatus body and the mounting unit and configured to move between a fitting position where the second connector is fitted to the first connector to electrically connect the apparatus body to the mounting unit and a release position where fitting of the second connector to the first connector is released, and an interlocking portion configured to move between a first operation position and a second operation position and configured to be interlocked with the restricting portion and the second connector, the interlocking portion moving from the first operation position to the second operation position so that the restricting portion moves from the restricting position to the allowing position and the second connector moves from the fitting position to the release position. The mounting unit is a fixing device configured to fix a toner image to the sheet by applying heat and pressure to the sheet.

Further features of the present invention will become apparent from the following description of exemplary embodiments with reference to the attached drawings.

### BRIEF DESCRIPTION OF THE DRAWINGS

FIG. 1A is a cross-sectional view showing an image forming apparatus.

FIG. 1B is a cross-sectional view showing the image forming apparatus in a state in which a manual feed tray is opened.

FIG. 2 is a cross-sectional view showing the image forming apparatus in a state in which a fixing device is removed.

FIG. 3A is a perspective view showing an interlocking unit when an operation lever is located at a first position.

FIG. 3B is a perspective view showing the interlocking unit when the operation lever is located at a third position.

FIG. 3C is a perspective view showing the interlocking unit when the operation lever is located at a second position.

FIG. 4A is a perspective view showing the image forming apparatus when the operation lever is located at the first position.

FIG. 4B is a perspective view showing the image forming apparatus when the operation lever is located at the second position.

FIG. 4C is an enlarged perspective view showing the operation lever in a state of being locked to a locking member.

FIG. 4D is a perspective view showing a state in which an apparatus body and a feeding deck are separated from each other.

FIG. 5 is an exploded perspective view showing the interlocking unit, a lock member, and a connector unit.

FIG. 6A is a side view showing the lock member when the operation lever is located at the first position.

FIG. 6B is a side view showing the lock member when the operation lever is located at the third position.

FIG. 6C is a side view showing the lock member when the operation lever is located at the second position.

FIG. 7 is an exploded perspective view showing the connector unit.

FIG. 8A is a side view showing the connector unit when the operation lever is located at the first position.

FIG. 8B is a cross-sectional view showing the connector unit when the operation lever is located at the third position.

FIG. 8C is a cross-sectional view showing the connector unit when the operation lever is located at the second position.

FIG. 9 is a perspective view showing an interlocking unit according to a modified example of a first embodiment.

FIG. 10 is a cross-sectional view showing an image forming apparatus according to a second embodiment.

FIG. 11 is a perspective view showing a fixing device.

FIG. 12 is a perspective view showing an interlocking unit and a fixing lock member.

FIG. 13A is an exploded perspective view showing the fixing device, a connector unit provided on a side of the fixing device, and a connector inserter.

FIG. 13B is an exploded perspective view showing the connector unit provided on a side of an apparatus body.

FIG. 14A is a perspective view showing a state in which a handle is operated to a second position.

FIG. 14B is a perspective view showing a state in which the fixing device is removed from the apparatus body.

FIG. 15A is a cross-sectional view showing the fixing lock member located at a restricting position.

FIG. 15B is a cross-sectional view showing the fixing lock member located at an allowing position.

FIG. 16A is a side view showing the connector unit when the handle is located at a first position.

FIG. 16B is a cross-sectional view showing a fixing-side connector and a body-side connector when the handle is located at the first position.

FIG. 16C is a cross-sectional view showing a state of a lifter cam.

FIG. 17A is a side view showing the connector unit when the handle is located at the second position.

FIG. 17B is a cross-sectional view showing the fixing-side connector and the body-side connector when the handle is located at the second position.

FIG. 17C is a cross-sectional view showing a state of the lifter cam.

FIG. 18A is a cross-sectional view showing the connector inserter and a connector holder during closing of a door.

FIG. 18B is a cross-sectional view showing the connector inserter and the connector holder when the door is located at a closed position.

### DESCRIPTION OF THE EMBODIMENTS

### First Embodiment

### Overall Configuration

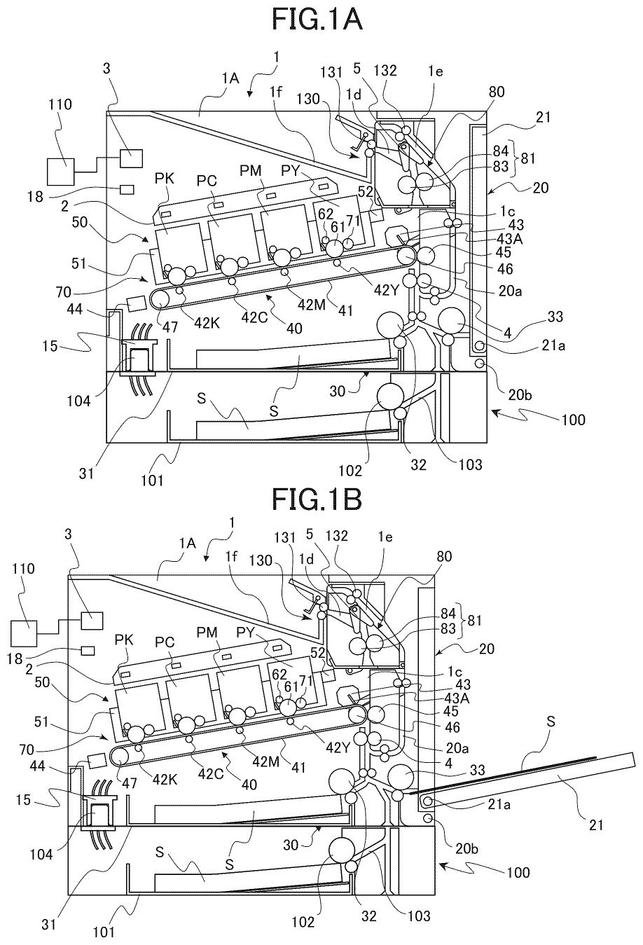

An image forming apparatus 1 according to the present embodiment is an electrophotographic full-color laser beam printer. FIG. 1A is a cross-sectional view showing the image forming apparatus 1, and FIG. 1B is a cross-sectional view showing the image forming apparatus 1 in a state in which a manual feed tray 21 is opened. Note that shapes of components described in each embodiment, relative arrangement thereof, and the like should be appropriately changed according to a configuration of an apparatus to which the invention is applied and various conditions, and the scope of the invention is not limited.

Note that the image forming apparatus includes a printer, a copier, a facsimile, and a multifunction peripheral, and refers to an apparatus that forms an image on a sheet used as a recording medium based on image information input from an external personal computer (PC) or image information read from a document. In addition to including the a having an image forming function, the image forming apparatus may be connected to accessory equipment such as an option feeder, an image reading device, or a sheet processing device, and the entire system to which such accessory equipment is connected is also a type of the image forming apparatus. The sheet includes paper such as a paper sheet or an envelope, a plastic film such as a sheet for an overhead projector (OHP), cloth, and the like.

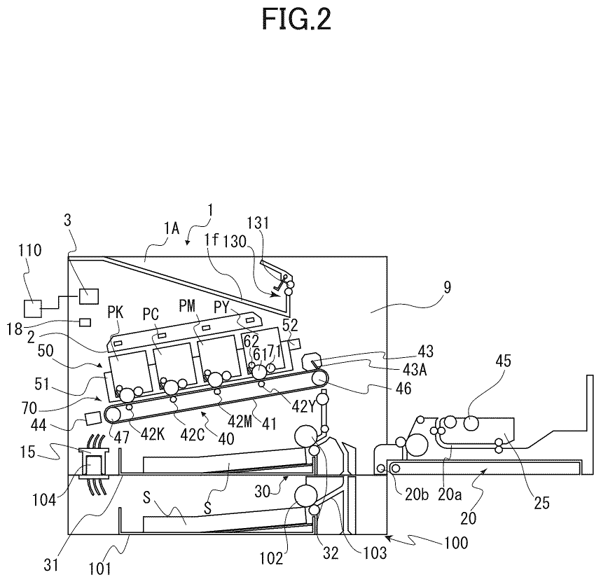

As shown in FIG. 1A, the image forming apparatus 1 includes an apparatus body 1A having an opening portion 9 (see FIG. 2), a door 20 serving as an opening and closing member, and a feeding deck 100 provided under the apparatus body 1A. The door 20 is configured to be pivotable with respect to the apparatus body 1A about a pivot shaft 20b between a closed position where the door 20 covers the opening portion 9 and an opened position where the door 20 opens the opening portion 9. Further, the door 20 pivotably supports the manual feed tray 21 around a pivot shaft 21a.

The apparatus body 1A accommodates an image forming unit 70 that forms an image on a sheet S, a feeding unit 30, a fixing device 80, and a discharge unit 130. The image forming unit 70 includes a transfer unit 40, a tray unit 50 disposed above the transfer unit 40, and a scanner 2 disposed above the tray unit 50.

The tray unit 50 includes a tray 51 that can be drawn out with respect to the apparatus body 1A, and four process cartridges PY, PM, PC, and PK that form toner images of four colors of yellow (Y), magenta (M), cyan (C), and black (K), respectively. The four process cartridges PY, PM, PC, and PK are placed on the tray 51. The tray 51 includes a tray handle 52 that can be gripped by a user.

The four process cartridges PY, PM, PC, and PK have the same configuration except that colors of images to be formed are different. Therefore, only the configuration and image forming process of the process cartridge PY will be described, and a description of the process cartridges PM, PC, and PK will be omitted.

The process cartridge PY includes a photosensitive drum 61, a charging roller 62, and a developing roller 71. The photosensitive drum 61 is formed by applying an organic photoconductive layer to an outer periphery of an aluminum cylinder, and is rotated by a drive motor (not shown). Directions of rotation axes of the photosensitive drum 61, the developing roller 71, and the charging roller 62 are parallel to each other.

The transfer unit 40 includes a driving roller 46, a tension roller 47, and an intermediate transfer belt 41 wound around the driving roller 46 and the tension roller 47. Primary transfer rollers 42Y, 42M, 42C, and 42K are provided on an inner side of the intermediate transfer belt 41. A secondary transfer roller 45 is provided so as to face the driving roller 46 such the intermediate transfer belt 41 is sandwiched between the secondary transfer roller 45 and the driving roller 46, and the intermediate transfer belt 41 and the secondary transfer roller 45 form a transfer nip for transferring the image to the conveyed sheet S. The image forming unit 70 includes an optical sensor 44 that detects the toner image transferred to the intermediate transfer belt 41. Directions of rotation axes of the primary transfer rollers 42Y, 42M, 42C, and 42K, the driving roller 46, the tension roller 47, and the secondary transfer roller 45 are parallel to each other.

The feeding unit 30 is provided at a lower portion of the image forming apparatus 1 and includes a cassette 31 on which the sheet S is stacked and a pickup roller 32 that feeds the sheet S stacked on the cassette 31. The cassette 31 is attachable to and detachable from the apparatus body 1A on the same side as the opening portion 9. The discharge unit 130 includes a discharge roller pair 131 and a discharge tray 1f on which the sheet S discharged by the discharge roller pair 131 is stacked.

The fixing device 80 includes a fixing unit 81 that fixes the toner image on the sheet to the sheet by applying heat and pressure to the sheet, a guide member 5, and a reverse roller pair 132. The fixing unit 81 includes a heating roller 83 incorporating a heater (not shown) and a pressure roller 84, and a fixing nip for nipping the sheet S is formed by the heating roller 83 and the pressure roller 84. The guide member 5 is pivotable between a discharge position where the guide member 5 guides the sheet S toward a discharge path 1d and a reverse position where the guide member 5 guides the sheet S toward a reverse path 1e.

The feeding deck 100 serving as a mounting unit and a stacking device has substantially the same configuration as the feeding unit 30, and includes a cassette 101 on which the sheet S is stacked, and a pickup roller 102 that feeds the sheet S stacked on the cassette 101. The cassette 101 is attachable to and detachable from the apparatus body 1A on the same side as the opening portion 9. The feeding deck 100 includes a deck-side connector 104, and the deck-side connector 104 serving as a first connector is fittable to a body-side connector 15 provided at the lower portion of the apparatus body 1A. When the deck-side connector 104 and the body-side connector 15 are fitted to each other, the apparatus body 1A and the feeding deck 100 are electrically connected to each other. When the sheet S stacked on the cassette 101 is fed by the pickup roller 102, the sheet S is conveyed toward a registration roller pair 4 of the apparatus body 1A through a feeder path 103.

In the present embodiment, “fitting” means that a first member and a second member are fitted to each other, unlike simple abutment or contact. In a state in which the first member and the second member are fitted to each other, the first member and the second member are also engaged in a direction orthogonal to a fitting direction.

Further, an environment sensor 18 and a control unit 3 are provided in the image forming apparatus 1. The environment sensor 18 can detect a temperature and a humidity of an environment in which the image forming apparatus 1 is installed. The control unit 3 includes a central processing unit (CPU), a read only memory (ROM), and a random access memory (RAM), and controls the image forming apparatus 1.

Next, an image forming operation of the image forming apparatus 1 configured as described above will be described. The image forming apparatus 1 includes the control unit 3 connected to an external host apparatus 110. The control unit 3 controls a scanner 2 to irradiate the photosensitive drum 61 of the process cartridge PY with laser light corresponding to an image signal based on the image signal received from the external host apparatus 110 or a reading unit. The external host apparatus 110 is, for example, a personal computer, an image reader, or a facsimile.

At this time, a surface of the photosensitive drum 61 is uniformly charged in advance to a predetermined polarity and potential by the charging roller 62, and an electrostatic latent image is formed on the surface of the photosensitive drum 61 by irradiation with the laser light from the scanner 2. The electrostatic latent image formed on the photosensitive drum 61 is developed by the developing roller 71, and a yellow (Y) toner image is formed on the photosensitive drum 61.

The developing roller 71 is configured to be able to abut against or be separated from the photosensitive drum 61. When the image forming apparatus 1 does not perform the image forming operation, the developing roller 71 is separated from the photosensitive drum 61, so that lives of the photosensitive drum 61 and the developing roller 71 can be extended.

Similarly, the respective photosensitive drums of the process cartridges PM, PC, and PK are also irradiated with laser light from the scanner 2, and toner images of magenta (M), cyan (C), and black (K) are formed on the respective photosensitive drums. The toner image of each color formed on each photosensitive drum is transferred to the intermediate transfer belt 41 by the primary transfer rollers 42Y, 42M, 42C, and 42K, and is conveyed to the transfer nip by the intermediate transfer belt 41 rotating by the driving roller 46. The image forming process for each color is performed at a timing of superimposing a toner image on an upstream toner image primarily transferred onto the intermediate transfer belt 41. The residual toner remaining on the photosensitive drum 61 is removed by a cleaning blade.

In parallel with the image forming process, the sheet S accommodated in the cassette 31 of the feeding unit 30 is fed to a conveyance path 1c by the pickup roller 32. Instead of the feeding unit 30, the sheet S may be fed from the feeding deck 100 or the manual feed tray 21. As shown in FIG. 1B, the manual feed tray 21 is used in a state of being opened from the door 20. The sheet S placed on the manual feed tray 21 is fed by the pickup roller 33 and conveyed toward the registration roller pair 4. Then, skew feeding of the sheet S is corrected by the registration roller pair 4 provided in the conveyance path 1c, and the sheet S is conveyed at a predetermined conveyance timing according to an image transfer timing at the transfer nip.

A full-color toner image on the intermediate transfer belt 41 is transferred to the sheet S at the transfer nip by a secondary transfer bias applied to the secondary transfer roller 45. The residual toner remaining on the intermediate transfer belt 41 is removed by a cleaning blade 43A provided in a cleaning unit 43. Predetermined heat and pressure are applied to the sheet S to which the toner image has been transferred by the heating roller 83 and the pressure roller 84 of the fixing device 80, and the toner is melted and fused (fixed). The sheet S having passed through the fixing device 80 is guided to the discharge path 1d or the reverse path le by the guide member 5.

When a single-sided print job for printing an image on only one side is input, the guide member 5 is located at the discharge position, and the sheet S is guided to the discharge path 1d. The sheet S guided to the discharge path 1d is discharged to the outside of the apparatus by the discharge roller pair 131 and is stacked on the discharge tray 1f.

When a double-sided printing job for forming an image on both sides of the sheet S is input, the sheet S having the image formed on a first side by the transfer nip is guided to the reverse path le by the guide member 5 located at the reverse position. The reverse roller pair 132 provided in the reverse path le is reversed after a trailing edge of the sheet S passes through the guide member 5 to switch back the sheet S. Here, the guide member 5 moves to the discharge position, and the switched-back sheet S is guided to a double-sided conveyance path 20a by the guide member 5.

The sheet S guided to the double-sided conveyance path 20a is conveyed to the conveyance path 1c by a plurality of conveyance roller pairs, and the image is formed on a second side at the transfer nip. Then, the sheet S is discharged to the discharge tray 1f by the discharge roller pair 131 after the toner image is fixed by the fixing device 80 as described above.

### Movements of Transfer Unit and Tray Unit

Next, movement of the transfer unit 40 and the tray unit 50 will be described with reference to FIG. 2. FIG. 2 is a cross-sectional view showing the image forming apparatus 1 in a state in which the door 20 is opened and the fixing device 80 is removed. As shown in FIG. 2, when the door 20 is opened, the opening portion 9 of the apparatus body 1A is opened. When the door 20 is moved to the opened position, the fixing device 80 is exposed to the outside of the image forming apparatus 1 through the opening portion 9. Therefore, the fixing device 80 can be removed to the outside of the image forming apparatus 1 via the opening portion 9. When the door 20 is opened from the closed position to the opened position, the opening portion 9 is opened, and the conveyance path 1c and the double-sided conveyance path 20a are exposed. As a result, the sheet S jammed in the conveyance path 1c or the double-sided conveyance path 20a can be handled. The door 20 pivotably supports a secondary transfer frame 25 that supports the secondary transfer roller 45. The double-sided conveyance path 20a can be largely opened by pivoting the secondary transfer frame 25 in a state in which the door 20 is located at the opened position.

Then, when the fixing device 80 is removed from the apparatus body 1A, a space in front of the transfer unit 40 and the tray unit 50 becomes empty. As a result, the transfer unit 40 and the tray unit 50 serving as image forming portions for forming the toner image on the sheet are attachable to and detachable from the apparatus body 1A via the opening portion 9. The user can draw out the tray unit 50 to the outside of the image forming apparatus 1 by gripping the tray handle 52 and drawing out the tray unit 50 toward the opening portion 9.

In a state in which the tray unit 50 is drawn out to the outside of the apparatus body 1A, the process cartridges PY, PM, PC, and PK are attachable to and detachable from the tray 51. Therefore, the process cartridges PY, PM, PC, and PK can be replaced. The transfer unit 40 can also be replaced. The image forming apparatus 1 can perform printing again by returning the tray unit 50 and the transfer unit 40 to the inside of the apparatus body 1A again and closing the door 20.

As described above, the fixing device 80, the transfer unit 40, and the tray unit 50 are all attachable and detachable through the door 20 of the image forming apparatus 1. Therefore, when the fixing device 80, the transfer unit 40, and the tray unit 50 are attached and detached, access can be made from one side of the image forming apparatus 1, usability can be improved, and an installation space when the image forming apparatus 1 is installed can be saved. In addition, since the cassettes 31 and 101 are also attachable to and detachable from the apparatus body 1A on the same side as the opening portion 9, it is possible to achieve usability improvement and space saving.

### Configurations of Interlocking Unit, Lock Member, and Connector Unit

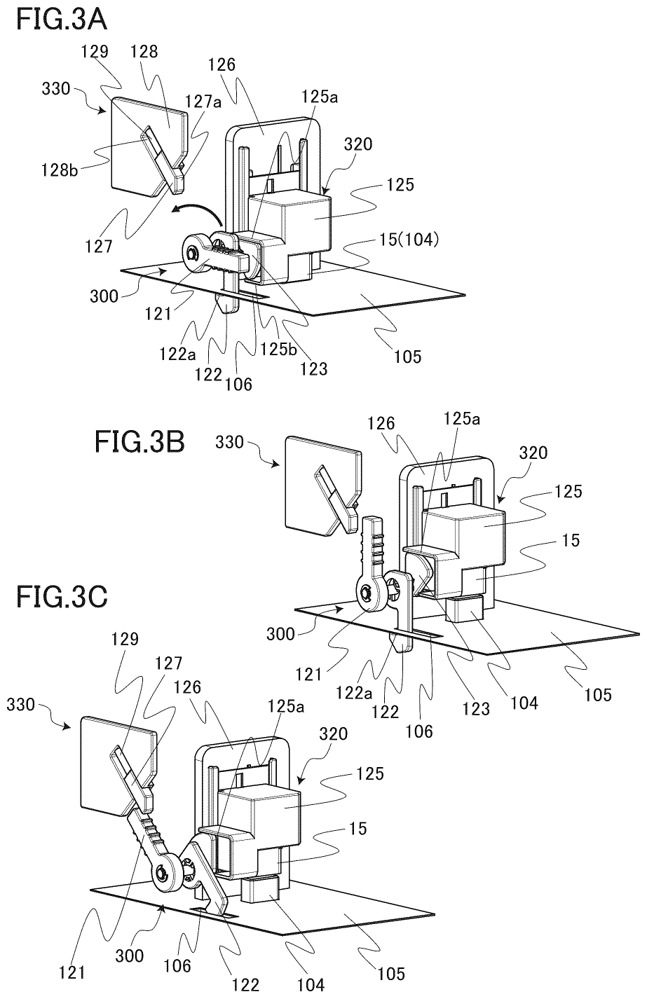

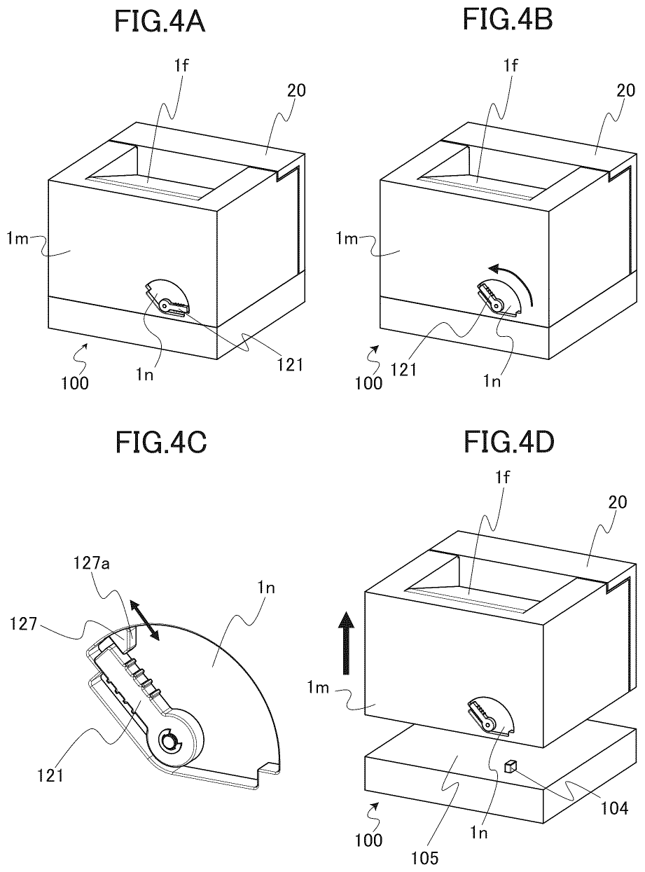

Next, an interlocking unit 300, a lock member 122, and a connector unit 320 provided in the apparatus body 1A will be described with reference to FIGS. 3A to 8C. FIG. 3A is a perspective view showing the interlocking unit 300 when an operation lever 121 is located at a first position, and FIG. 3B is a perspective view showing the interlocking unit 300 when the operation lever 121 is located at a third position. FIG. 3C is a perspective view showing the interlocking unit 300 when the operation lever 121 is located at a second position. FIG. 4A is a perspective view showing the image forming apparatus 1 when the operation lever 121 is located at the first position, and FIG. 4B is a perspective view showing the image forming apparatus 1 when the operation lever 121 is located at the second position. FIG. 4C is an enlarged perspective view showing the operation lever 121 in a state of being locked to a stopper 127, and FIG. 4D is a perspective view showing a state in which the apparatus body 1A and the feeding deck 100 are separated from each other.

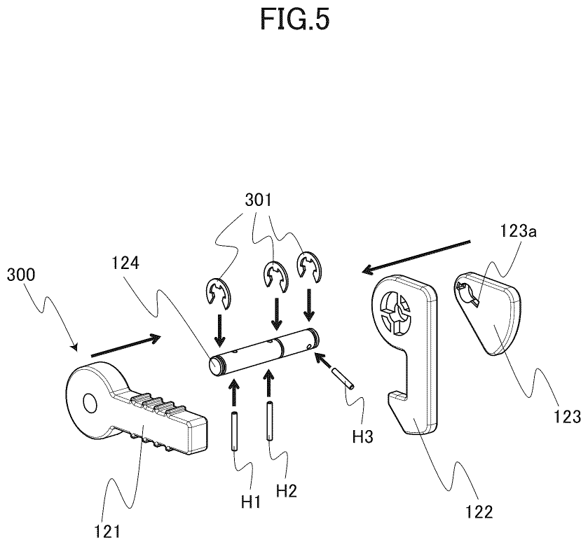

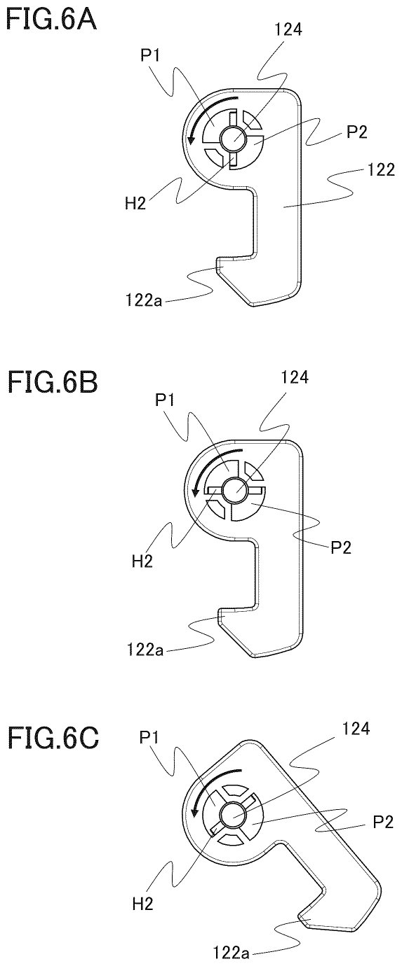

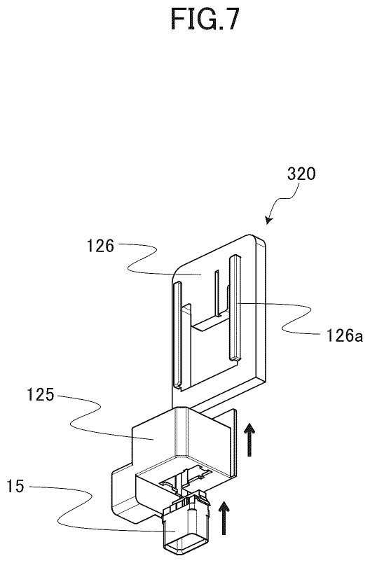

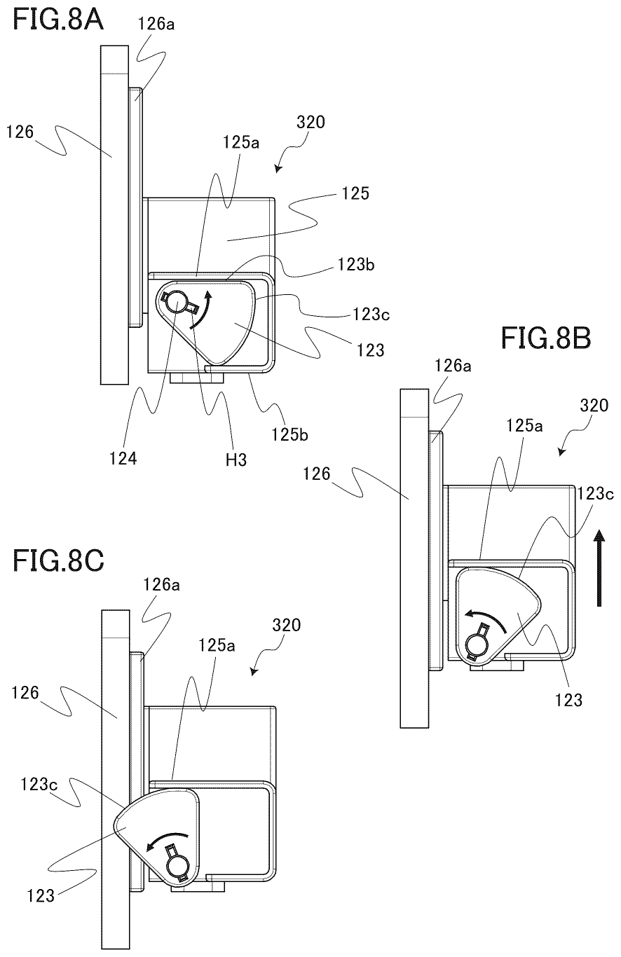

FIG. 5 is an exploded perspective view showing the interlocking unit 300, the lock member 122, and the connector unit 320. FIG. 6A is a side view showing the lock member 122 when the operation lever 121 is located at the first position, and FIG. 6B is a side view showing the lock member 122 when the operation lever 121 is located at the third position. FIG. 6C is a side view showing the lock member 122 when the operation lever 121 is located at the second position. FIG. 7 is an exploded perspective view showing the connector unit 320. FIG. 8A is a side view showing the connector unit 320 when the operation lever 121 is located at the first position, and FIG. 8B is a cross-sectional view showing the connector unit 320 when the operation lever 121 is located at the third position. FIG. 8C is a cross-sectional view showing the connector unit 320 when the operation lever 121 is located at the second position.

As shown in FIG. 3A, the interlocking unit 300 serving as an interlocking portion, the lock member 122 serving as a restricting portion provided so as to be interlocked with the interlocking unit 300, and the connector unit 320 are provided in the apparatus body 1A. The interlocking unit 300 includes the pivotable operation lever 121, and the lock member 122 and the connector unit 320 move when the operation lever 121 serving as an operation portion is operated by the user.

As shown in FIG. 4A, the image forming apparatus 1 has a back surface 1m opposite to the door 20, and the back surface 1m is provided with a recess 1n in which the operation lever 121 is movably accommodated. The recess 1n is formed in a substantially fan shape so as not to interfere with a movement locus of the operation lever 121.

As shown in FIG. 4A, the operation lever 121 is located at the first position in a state in which the feeding deck 100 is mounted on the apparatus body 1A. As shown in FIGS. 4B to 4D, when the operation lever 121 pivots from the first position to the second position, the feeding deck 100 can be separated from the apparatus body 1A. A position of the interlocking unit 300 when the operation lever 121 is located at the first position is defined as a first operation position, and a position of the interlocking unit 300 when the operation lever 121 is located at the second position is defined as a second operation position. A position of the interlocking unit 300 when the operation lever 121 is located at the third position described below is defined as a third operation position.

As shown in FIG. 5A, the interlocking unit 300 includes an interlocking shaft 124 pivotably supported by a frame (not shown) of the apparatus body 1A, parallel pins H1, H2, and H3 fixed to the interlocking shaft 124, the operation lever 121, and three E-rings 301. The operation lever 121, the lock member 122, and a connector cam 123 are pivotably supported by the interlocking shaft 124 serving as a pivot shaft. The operation lever 121 pivots integrally with the interlocking shaft 124 by being fitted to the parallel pin H1. The operation lever 121 is positioned in a thrust direction by the parallel pin H1 and the E-ring 301.

As shown in FIGS. 3A and 4C, a stopper unit 330 is disposed above the operation lever 121. The stopper unit 330 includes a stopper holder 128 supported by the frame (not shown) of the apparatus body 1A, the stopper 127 movably supported by the stopper holder 128, and a biasing spring 129 that biases the stopper 127. The stopper holder 128 is provided with a guide groove 128b, and the stopper 127 is slidable along the guide groove 128b. The stopper 127 is biased to a predetermined locking position by the biasing spring 129. A tapered surface 127a is provided at a distal end portion of the stopper 127.

As shown in FIGS. 4A, 4B, and 4C, when the operation lever 121 pivots from the first position toward the second position, the operation lever 121 abuts on the tapered surface 127a of the stopper 127 located at the locking position. When the operation lever 121 further pivots toward the second position, the operation lever 121 presses the tapered surface 127a, and the stopper 127 retracts upward from the locking position. When the operation lever 121 moves over the tapered surface 127a of the stopper 127, the operation lever 121 reaches the second position, and the stopper 127 returns to the locking position by a biasing force of the biasing spring 129. As a result, the stopper 127 serving as a locking portion is locked to the operation lever 121 located at the second position, at the locking position, and the operation lever 121 can be held at the second position.

The connector cam 123 serving as a cam is provided with a pin groove 123a to be fitted to the parallel pin H3. Therefore, the connector cam 123 pivots integrally with the interlocking shaft 124 by being fitted to the parallel pin H3. The connector cam 123 is positioned in the thrust direction by the parallel pin H3 and the E-ring 301.

The lock member 122 is provided so as to be engageable with the parallel pin H2 with predetermined plays P1 and P2 in FIGS. 5 and 6A. Further, the lock member 122 is positioned in the thrust direction by the parallel pin H2 and the E-ring 301. As shown in FIG. 6A, the parallel pin H2 is rotatable relative to the lock member 122 within a range of the plays P1 and P2. As shown in FIGS. 6A and 6B, during the pivoting of the operation lever 121 from the first position to the third position, the parallel pin H2 passes through the plays P1 and P2, and thus, the operation lever 121 and the lock member 122 are not interlocked. As shown in FIG. 6B, when the operation lever 121 reaches the third position, the parallel pin H2 abuts on the lock member 122. As shown in FIGS. 6B and 6C, when the operation lever 121 pivots from the third position to the second position, the operation lever 121 and the lock member 122 are interlocked, and the operation lever 121 and the lock member 122 pivot integrally.

On the other hand, during the pivoting of the operation lever 121 from the second position to the third position, the operation lever 121 and the lock member 122 pivot integrally. During the pivoting of the operation lever 121 from the third position to the first position, the parallel pin H2 passes through the plays P1 and P2, and thus, the operation lever 121 and the lock member 122 are not interlocked.

As shown in FIGS. 3A to 3C, an upper surface 105 of the feeding deck 100 is provided with an engagement hole portion 106, and the lock member 122 has a locking claw 122a that can be locked to the engagement hole portion 106. As shown in FIGS. 3A and 6A, when the operation lever 121 is located at the first position, the lock member 122 is located at a restricting position for restricting the removal of the feeding deck 100 from the apparatus body 1A. In other words, at the restricting position, the lock member 122 restricts movement of the feeding deck 100 from a mounting position where the feeding deck 100 is mounted on the apparatus body 1A. At this time, a distal end portion of the lock member 122 passes through a hole defined by the engagement hole portion 106, and the locking claw 122a is locked to the engagement hole portion 106.

As shown in FIGS. 3B and 6B, when the operation lever 121 is located at the third position, the lock member 122 is also located at the restricting position. This is because, as described above, even when the parallel pin H2 pivots integrally with the operation lever 121, the parallel pin H2 passes through the plays P1 and P2, and the operation lever 121 and the lock member 122 do not interlock with each other. As shown in FIGS. 3C and 6C, when the operation lever 121 is located at the second position, the lock member 122 is located at an allowing position for allowing the feeding deck 100 to be removed from the apparatus body 1A. In other words, at the allowing position, the lock member 122 allows the movement of the feeding deck 100 from the mounting position where the feeding deck 100 is mounted on the apparatus body 1A. At this time, the locking of the locking claw 122a and the engagement hole portion 106 is released at the distal end portion of the lock member 122, and upward movement of the lock member 122 is allowed.

As shown in FIG. 7, the connector unit 320 includes a guide portion 126 supported by the frame (not shown) of the apparatus body 1A, a connector holder 125, and the body-side connector 15 attached to the connector holder 125. The connector holder 125 is slidably supported by a guide rail 126a of the guide portion 126, and the body-side connector 15 serving as a second connector moves integrally with the connector holder 125.

As shown in FIGS. 3A and 8A, the connector holder 125 is provided with an upper rib 125a and a lower rib 125b arranged so as to sandwich the connector cam 123 in a vertical direction. As shown in FIG. 8A, when the operation lever 121 is located at the first position, a side surface 123b of the connector cam 123 abuts on the upper rib 125a, and a cam surface 123c of the connector cam 123 abuts on the lower rib 125b. At this time, as shown in FIG. 4D, the body-side connector 15 attached to the connector holder 125 is located at a fitting position where the body-side connector 15 is fitted to the deck-side connector 104 protruding upward from the upper surface 105 of the feeding deck 100.

As shown in FIG. 8B, when the operation lever 121 is located at the third position, the cam surface 123c of the connector cam 123 abuts on the upper rib 125a. At this time, as shown in FIG. 3B, the body-side connector 15 is located at a release position where the fitting to the deck-side connector 104 is released. When the body-side connector 15 is located at the release position, the electrical connection between the apparatus body 1A and the feeding deck 100 is released. Similarly, as shown in FIGS. 3C and 8C, when the operation lever 121 is located at the second position, the cam surface 123c of the connector cam 123 abuts on the upper rib 125a, and the body-side connector 15 is located at the release position.

### Motions of Lock Member and Body-Side Connector When Operation Lever Is Operated

Next, motions of the lock member 122 and the body-side connector 15 when the operation lever 121 is operated by the user will be described. As shown in FIG. 4A, when the image forming apparatus 1 is in use, the feeding deck 100 is attached to the apparatus body 1A, and the operation lever 121 is located at the first position. At this time, as shown in FIG. 3A, the lock member 122 is located at the restricting position, and the body-side connector 15 is located at the fitting position. That is, the separation between the apparatus body 1A and the feeding deck 100 is restricted by the lock member 122 located at the restricting position. When the body-side connector 15 located at the fitting position and the deck-side connector 104 are fitted to each other, the apparatus body 1A and the feeding deck 100 are electrically connected to each other.

As shown in FIG. 4B, when the operation lever 121 pivots from the first position in an arrow direction, first, the operation lever 121 reaches the third position as shown in FIG. 3B. When the operation lever 121 pivots from the first position to the third position, the connector cam 123 pivots from a position shown in FIG. 8A to a position shown in FIG. 8B. At this time, the upper rib 125a of the connector holder 125 is pressed upward by the cam surface 123c of the connector cam 123, and the connector holder 125 and the body-side connector 15 move upward. Accordingly, the body-side connector 15 moves from the fitting position to the release position. Therefore, the fitting between the body-side connector 15 and the deck-side connector 104 is released, and the electrical connection between the apparatus body 1A and the feeding deck 100 is also released.

When the operation lever 121 moves from the first position to the third position, the lock member 122 does not pivot and is held at the restricting position as described above. This is because the plays P1 and P2 are provided in the lock member 122.

When the operation lever 121 pivots from the third position to the second position as shown in FIGS. 3B and 3C, there is no substantial change in a height of an abutment point between the cam surface 123c of the connector cam 123 and the upper rib 125a of the connector holder 125 as shown in FIGS. 8B and 8C. Therefore, the body-side connector 15 attached to the connector holder 125 is held at the release position even when the operation lever 121 pivots from the third position to the second position.

The body-side connector 15 may move further upward than the release position when the operation lever 121 pivots from the third position to the second position. However, when the body-side connector 15 is held at the release position as in the present embodiment, a space for the connector holder 125 and the body-side connector 15 to move further upward than the release position becomes unnecessary, which is advantageous for downsizing the image forming apparatus 1.

When the operation lever 121 pivots from the third position to the second position, the lock member 122 pivots from the restricting position to the allowing position. As a result, the locking between the lock member 122 and the feeding deck 100 is released, and the apparatus body 1A and the feeding deck 100 can be separated from each other.

As shown in FIG. 4C, the operation lever 121 is held at the second position by the stopper 127 located at the locking position. Therefore, it is possible to restrict the operation lever 121 from returning from the second position toward the first position by weights of the connector holder 125, the body-side connector 15, the lock member 122, the connector cam 123, and the like.

Then, as shown in FIG. 4D, the user can separate the apparatus body 1A and the feeding deck 100 by lifting the apparatus body 1A upward, and can remove the feeding deck 100 from the apparatus body 1A. When mounting the feeding deck 100 on the apparatus body 1A again, the user places the apparatus body 1A on the feeding deck 100 and then pivots the operation lever 121 from the second position to the first position. Accordingly, after the lock member 122 pivots from the allowing position to the restricting position, the body-side connector 15 moves from the release position to the fitting position.

As described above, in the present embodiment, the lock member 122 and the body-side connector 15 can be moved by operating the operation lever 121. In other words, the interlocking unit 300 including the operation lever 121 is configured to be able to be interlocked with the lock member 122 and the body-side connector 15.

When the operation lever 121 pivots between the first position and the second position, a timing at which the lock member 122 pivots is different from a timing at which the body-side connector 15 moves. Specifically, the operation lever 121 can take the third position between the first position and the second position, and when the operation lever 121 pivots between the first position and the third position, the lock member 122 does not pivot from the restricting position, and only the body-side connector 15 moves between the fitting position and the release position. Further, when the operation lever 121 pivots between the third position and the second position, the body-side connector 15 does not move from the fitting position, and only the lock member 122 pivots between the restricting position and the allowing position.

As described above, when the operation lever 121 is operated, an operation force for the operation lever 121 can be reduced by making the timing at which the lock member 122 pivots different from the timing at which the body-side connector 15 moves.

In a state in which the operation lever 121 is located at the second position, the lock member 122 is located at the allowing position, and the body-side connector 15 is located at the release position. In this state, the user separates the feeding deck 100 from the apparatus body 1A by lifting the apparatus body 1A. Therefore, a force for pulling out the body-side connector 15 from the deck-side connector 104 is not required when lifting the apparatus body 1A. Similarly, a force for fitting the body-side connector 15 to the deck-side connector 104 is not required when placing the feeding deck 100 on the apparatus body 1A. Therefore, workability at the time of attaching and detaching the feeding deck 100 can be improved. In other words, workability when the feeding deck 100 moves from the mounting position can be improved.

In plan view, the body-side connector 15 is disposed at a position not overlapping with the center of gravity of each of the apparatus body 1A and the feeding deck 100. Therefore, in a case where insertion and removal of the body-side connector 15 and the deck-side connector 104 are necessary when attaching and detaching the feeding deck 100 to and from the apparatus body 1A, a force for lifting the apparatus body 1A is not well balanced, which causes a decrease in workability. However, in the present embodiment, the apparatus body 1A is lifted after the body-side connector 15 is pulled out from the deck-side connector 104. Therefore, it is possible to improve the balance of the force for lifting the apparatus body 1A, and it is possible to improve workability when removing the feeding deck 100 from the apparatus body 1A.

In the present embodiment, the operation lever 121 is provided on the back surface 1m of the apparatus body 1A, but the present technology is not limited thereto. For example, the operation lever 121 may be provided at another position on the apparatus body 1A.

The interlocking unit 300 including the operation lever 121 and the lock member 122 may be provided not in the apparatus body 1A but in the feeding deck 100. At this time, the deck-side connector 104 is preferably configured to be movable instead of the body-side connector 15. That is, a connector movable between the fitting position and the release position may be provided in any one of the apparatus body 1A and the feeding deck 100, and a connector that does not move may be provided in the other one of the apparatus body 1A and the feeding deck 100.

### Modified Example of First Embodiment

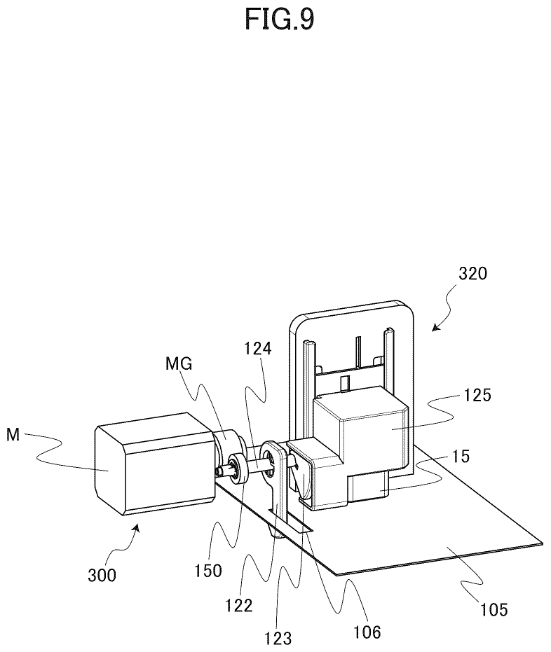

Next, a modified example of the first embodiment will be described with reference to FIG. 9. FIG. 9 is a perspective view showing an interlocking unit 300 according to the modified example of the first embodiment. In the present modified example, the interlocking unit 300 is operated by a motor M instead of the operation lever 121. The motor M serving as an actuator includes a pinion gear MG fixed to an output shaft, and the pinion gear MG meshes with a gear 150 fixed to the interlocking shaft 124. Therefore, when the motor M is driven, the interlocking shaft 124 rotates. Operations of a lock member 122 and a body-side connector 15 when the interlocking shaft 124 rotates are similar to those in the first embodiment. Instead of the motor M, another actuator such as a solenoid may be applied.

In the first embodiment and the modified example, the lock member 122 and the connector cam 123 for moving the body-side connector 15 are pivotably supported by the same interlocking shaft 124, but the present technology is not limited thereto. For example, the lock member 122 and the connector cam 123 may be supported by separate shafts. When the operation lever 121 or the motor M is operated, the separate shafts may be controlled to rotate. Even in this case, it is desirable that the lock member 122 move to the allowing position after the body-side connector 15 is located at the release position.

### Second Embodiment

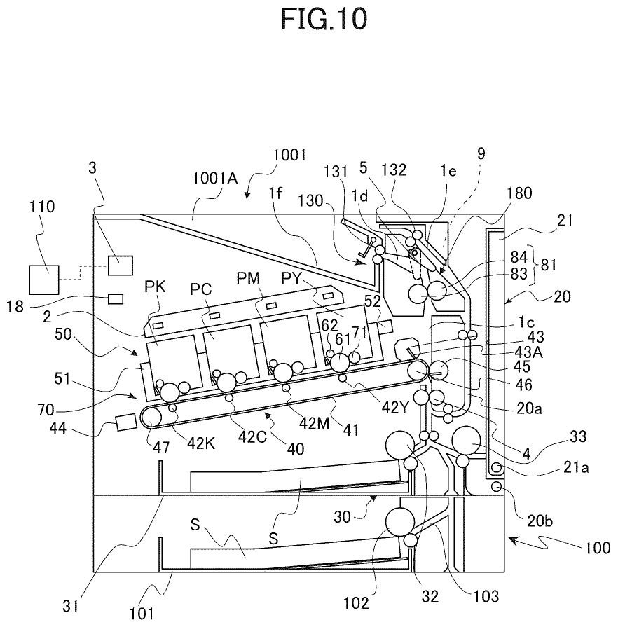

Next, a second embodiment of the present invention will be described. In the second embodiment, a fixing device 180 and an apparatus body 1001A are connected by a connector. Therefore, a configuration similar to that of the first embodiment will be described in a manner of omitting illustration or attaching the same reference numerals in the drawings. FIG. 10 is a cross-sectional view illustrating an image forming apparatus 1001 according to the second embodiment.

As shown in FIG. 10, the image forming apparatus 1001 according to the present embodiment includes the apparatus body 1001A having an opening portion 9, a door 20, and a feeding deck 100. The door 20 is supported so as to be openable and closable with respect to the apparatus body 1001A between a closed position where the door 20 covers the opening portion 9 and an opened position where the door 20 opens the opening portion 9. Similarly to the first embodiment, the apparatus body 1001A accommodates an image forming unit 70, a feeding unit 30, the fixing device 180, and a discharge unit 130.

The fixing device 180 includes a fixing unit 81 that fixes a toner image on a sheet to the sheet by applying heat and pressure to the sheet, a guide member 5, and a reverse roller pair 132. The fixing unit 81 includes a heating roller 83 incorporating a heater (not shown) and a pressure roller 84, and a fixing nip for nipping a sheet S is formed by the heating roller 83 and the pressure roller 84. Since an image forming operation of the image forming apparatus 1001 is similar to that of the first embodiment, a description thereof will be omitted.

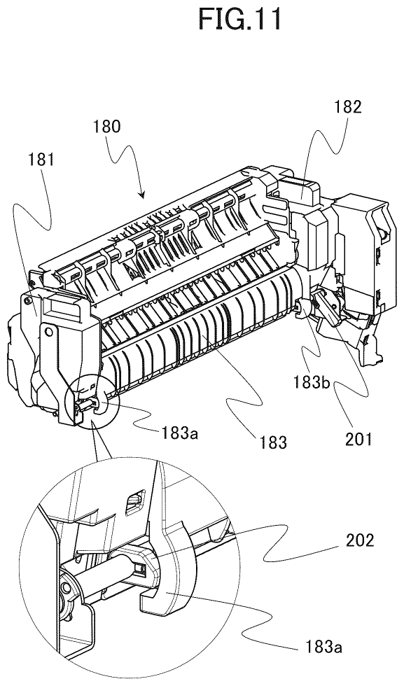

FIG. 11 is a perspective view showing the fixing device 180 serving as a mounting unit. FIG. 11 illustrates a state in which a user can access the fixing device 180 through the opening portion 9 by opening the door 20, and does not illustrate the apparatus body 1001A.

As shown in FIG. 11, the fixing device 180 includes a left fixing cover 181, a right fixing cover 182, and a front fixing cover 183. The front fixing cover 183 is provided with locked portions 183a and 183b. The apparatus body 1001A is provided with a guide member (not shown), and the fixing device 180 is supported by the guide member so as to be movable in a vertical direction. The fixing device 180 is removable from the apparatus body 1001A by moving upward from the apparatus body 1001A in a state in which a fixing lock member 202 described below is located at an allowing position.

### Configurations of Interlocking Unit, Fixing Lock Member, and Connector Unit

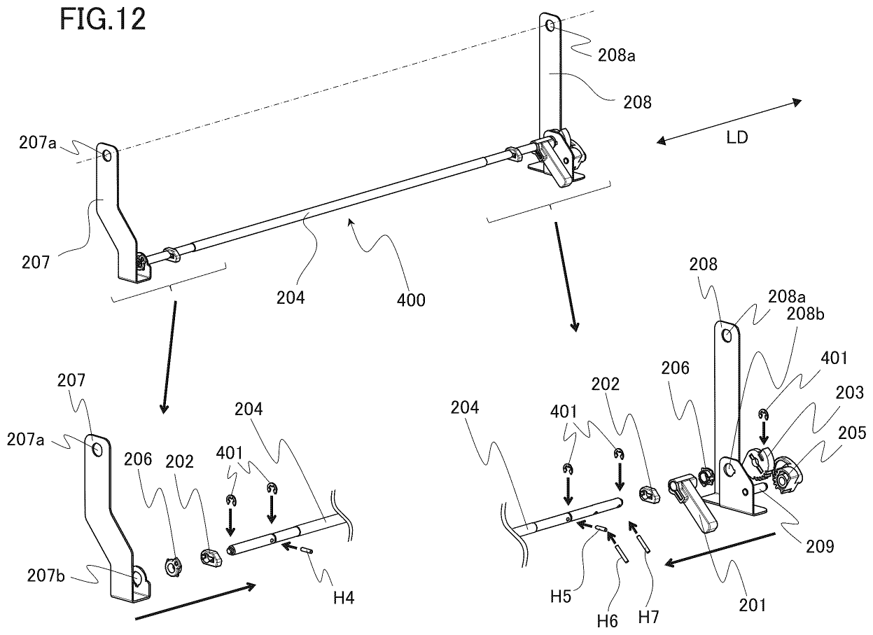

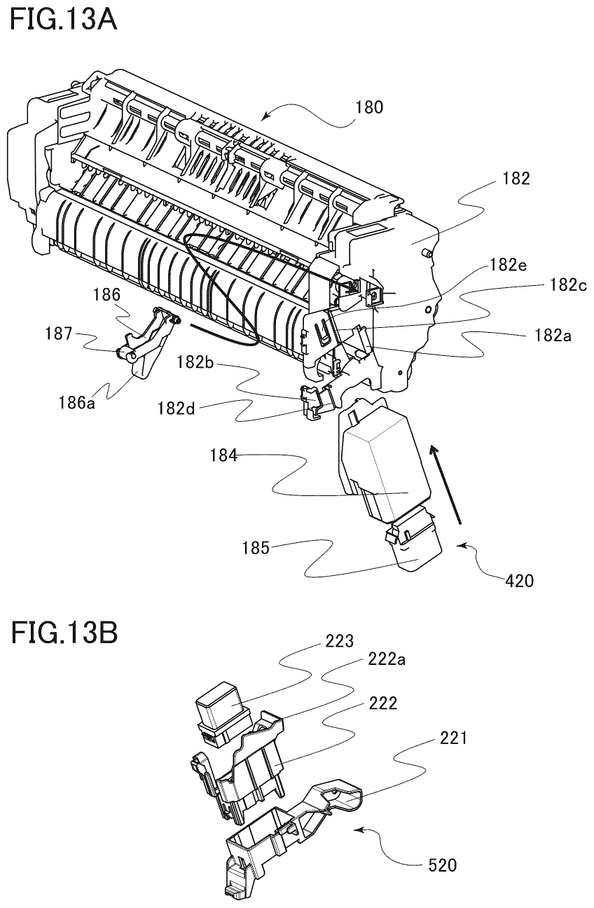

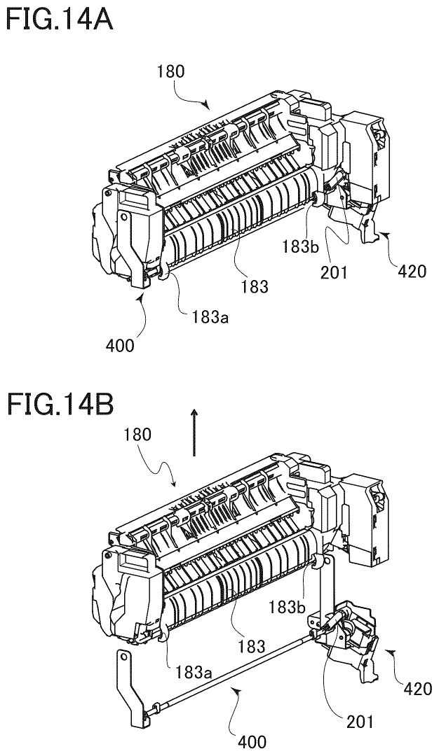

Next, an interlocking unit 400, the fixing lock member 202, and connector units 420 and 520 provided in the apparatus body 1001A will be described with reference to FIGS. 12 to 18B. FIG. 12 is a perspective view showing the interlocking unit 400 and the fixing lock member 202. FIG. 13A is an exploded perspective view showing the fixing device 180, the connector unit 420 provided on a side of the fixing device 180, and a connector inserter 186, and FIG. 13B is an exploded perspective view showing the connector unit 520 provided on a side of the apparatus body 1001A. FIG. 14A is a perspective view showing a state in which a handle 201 is operated to a second position, and FIG. 14B is a perspective view showing a state in which the fixing device 180 is removed from the apparatus body 1001A.

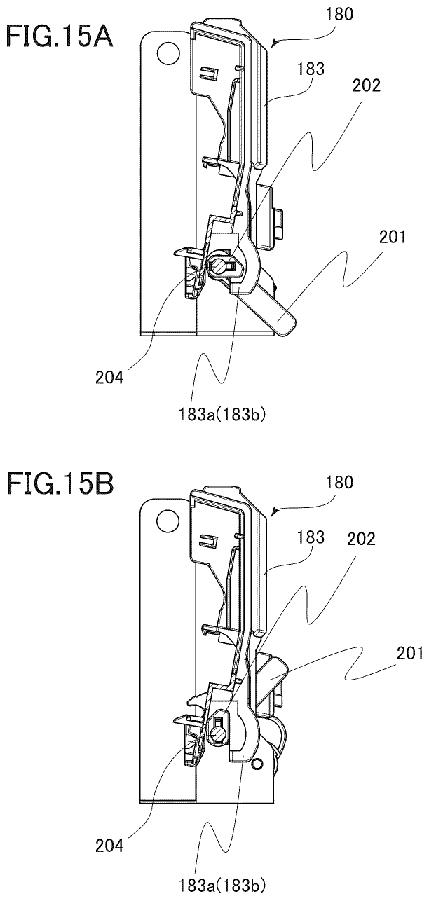

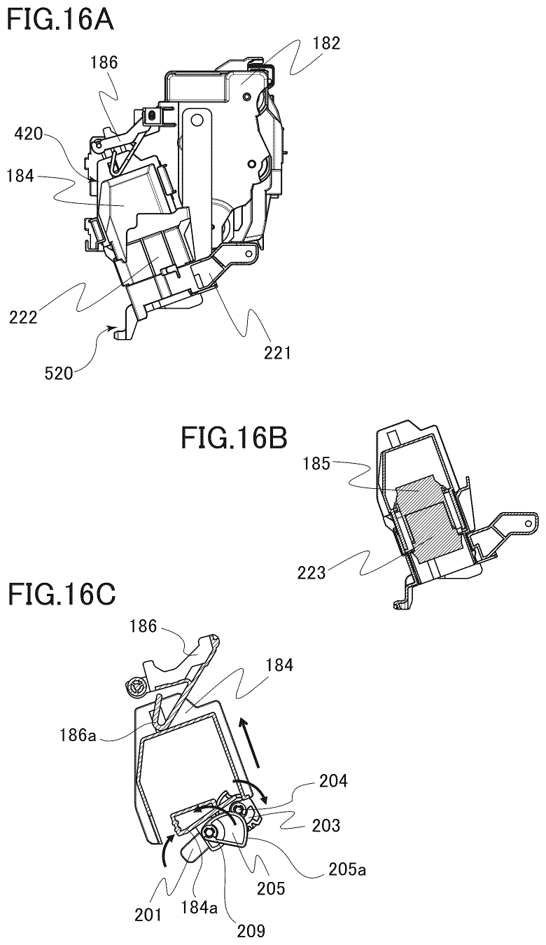

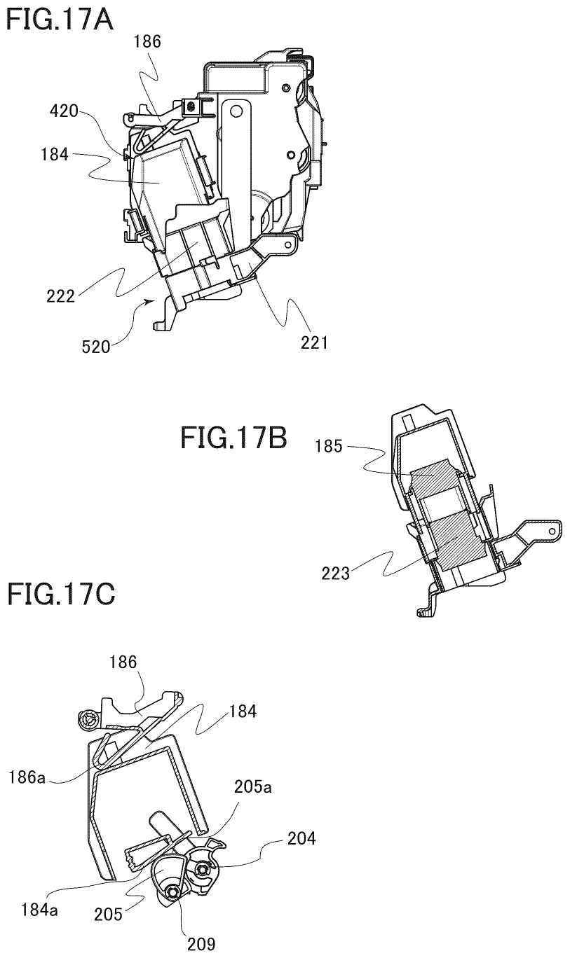

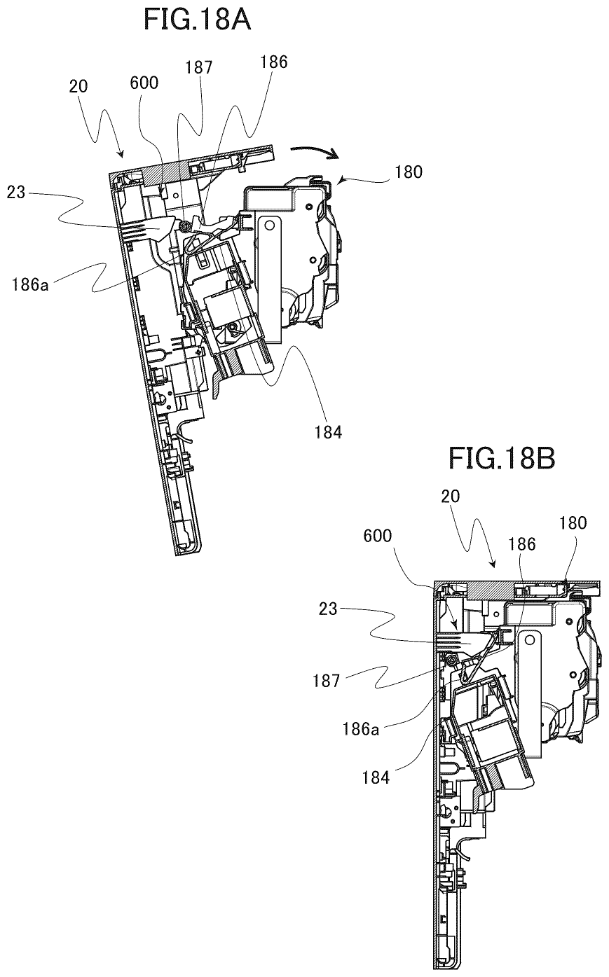

FIG. 15A is a cross-sectional view showing the fixing lock member 202 located at a restricting position, and FIG. 15B is a cross-sectional view showing the fixing lock member 202 located at the allowing position. FIG. 16A is a side view showing the connector units 420 and 520 when the handle 201 is located at a first position. FIG. 16B is a cross-sectional view showing a fixing-side connector 185 and a body-side connector 223 when the handle 201 is located at the first position, and FIG. 16C is a cross-sectional view showing a state of a lifter cam 205. FIG. 17A is a side view showing the connector units 420 and 520 when the handle 201 is located at the second position. FIG. 17B is a cross-sectional view showing the fixing-side connector 185 and the body-side connector 223 when the handle 201 is located at the second position, and FIG. 17C is a cross-sectional view showing a state of the lifter cam 205. FIG. 18A is a cross-sectional view showing the connector inserter 186 and a connector holder 184 during closing of the door 20. FIG. 18B is a cross-sectional view showing the connector inserter 186 and the connector holder 184 when the door 20 is located at the closed position.

As shown in FIG. 12, the interlocking unit 400 serving as an interlocking portion is provided in the apparatus body 1001A. The interlocking unit 400 mainly includes left and right frame members 207 and 208 and an interlocking shaft 204 rotatably supported by the frame members 207 and 208. More specifically, the frame members 207 and 208 are spaced apart from each other in a longitudinal direction LD of the fixing device 180. The fixing device 180 mounted on the apparatus body 1001A is disposed between the frame members 207 and 208. The interlocking shaft 204 serving as a pivot shaft extends in the longitudinal direction LD. The interlocking shaft 204 may support a lower surface of the fixing device 180.

The frame member 207 has holes 207a and 207b, and the frame member 208 has holes 208a and 208b. The holes 207a and 208a are coaxially arranged and connected to shafts provided in the apparatus body 1001A. Therefore, the frame members 207 and 208 are pivotably supported by the apparatus body 1001A.

Bearings 206 and 206 are attached to the holes 207b and 208b, respectively. The bearings 206 and 206 attached to the holes 207b and 208b rotatably support the interlocking shaft 204. Fixing lock members 202 and 202, the handle 201, and a ring gear 203 are fixed to the interlocking shaft 204 via parallel pins H4, H5, H6, and H7, respectively. The fixing lock members 202 and 202, the handle 201, and the ring gear 203 are positioned in a thrust direction by the parallel pins H4, H5, H6, and H7 and E-rings 401.

The right frame member 208 is provided with a camshaft 209, and the camshaft 209 rotatably supports the lifter cam 205. When the handle 201 serving as an operation portion is operated to rotate the interlocking shaft 204, the ring gear 203 also rotates integrally with the interlocking shaft 204. The ring gear 203 meshes with the lifter cam 205, and the lifter cam 205 rotates about the camshaft 209 as the ring gear 203 rotates. As described below, the lifter cam 205 serving as a cam is configured to be able to lift and lower the fixing-side connector 185. As described above, the interlocking unit 400 includes the frame members 207 and 208, the interlocking shaft 204, the ring gear 203, the lifter cam 205, and the like, and is configured to be interlocked with the fixing lock members 202 and 202 and the fixing-side connector 185.

In the present embodiment, in a state in which the fixing device 180 is removed from the apparatus body 1001A, the interlocking unit 400 is disposed in the opening portion 9 opened when the door 20 is opened. Similarly to the first embodiment, when a tray unit 50 is drawn out from the apparatus body 1001A, the interlocking unit 400 is pressed by the tray unit 50 and pivots about the holes 207a and 208a. In other words, the interlocking unit 400 is configured to be retractable so as not to interfere with a movement locus of the tray unit 50 when the tray unit 50 is moved toward the opening portion 9. Further, the interlocking unit 400 is configured to be retractable so as not to interfere with a movement locus of a transfer unit 40. As a result, even when the tray unit 50 is drawn out from the apparatus body 1001A, the interlocking unit 400 does not interfere with the drawing of the tray unit 50, and usability can be improved.

As shown in FIG. 13A, the right fixing cover 182 is provided with eave portions 182a and 182b and grooves 182c and 182d, and the cave portions 182a and 182b and the grooves 182c and 182d support the connector holder 184 of the connector unit 420 in a liftable and lowerable manner. The fixing-side connector 185 serving as a second connector is attached to the connector holder 184. The right fixing cover 182 is provided with a claw portion 182e that is engaged with a hole portion provided in the connector holder 184 to prevent the connector holder 184 from falling off from the right fixing cover 182.

Further, the connector inserter 186 is pivotably supported by the right fixing cover 182, and the connector inserter 186 is disposed above the connector holder 184. The connector inserter 186 rotatably supports a driven roller 187. An elastically deformable elastic portion 186a is provided at a lower portion of the connector inserter 186.

As shown in FIG. 13B, the connector unit 520 is provided on the apparatus body 1001A. The connector unit 520 includes a base member 221 attached to the apparatus body 1001A, a connector holder 222 held by the base member 221 with backlash, and the body-side connector 223 serving as a first connector attached to the connector holder 222. The connector holder 222 has a tapered surface 222a that guides the fixing-side connector 185 toward the body-side connector 223.

As shown in FIGS. 11 and 15A, when the handle 201 is located at the first position, the left and right fixing lock members 202 serving as restricting portions are located at the restricting positions for restricting the removal of the fixing device 180 from the apparatus body 1001A. In other words, at the restricting position, the fixing lock member 202 restricts movement of the fixing device 180 from a mounting position where the fixing device 180 is mounted on the apparatus body 1001A. The fixing device 180 is located at the mounting position in FIGS. 10, 11, and 14A. At this time, the left and right fixing lock members 202 and 202 are engaged with the locked portions 183a and 183b provided on the front fixing cover 183, respectively. As a result, the movement of the fixing device 180 is restricted.

As shown in FIGS. 14A and 15B, when the handle 201 is located at the second position, the left and right fixing lock members 202 are located at the allowing positions for allowing the removal of the fixing device 180 from the apparatus body 1001A. In other words, at the allowing position, the fixing lock member 202 allows movement of the fixing device 180 from the mounting position where the fixing device 180 is mounted on the apparatus body 1001A. At this time, the left and right fixing lock members 202 and 202 are disengaged from the locked portions 183a and 183b, respectively. As a result, the fixing device 180 can be removed upward toward the outside of the apparatus body 1001A. When the door 20 is opened, the handle 201 is located at the first position and is configured to be pivotable upward from the first position to the second position by the user. A position of the interlocking unit 400 when the handle 201 is located at the first position is defined as a first operation position, and a position of the interlocking unit 400 when the handle 201 is located at the second position is defined as a second operation position.

As shown in FIGS. 16A and 16C, the connector holder 184 of the connector unit 420 on the side of the fixing device 180 has a pressed surface 184a facing the lifter cam 205. When the handle 201 is located at the first position, the pressed surface 184a of the connector holder 184 is not yet lifted up by the lifter cam 205. Therefore, as shown in FIG. 16B, the fixing-side connector 185 held by the connector holder 184 is located at a fitting position where the fixing-side connector 185 is fitted to the body-side connector 223 to electrically connect the apparatus body 1001A and the fixing device 180.

As shown in FIG. 17C, when the handle 201 pivots from the first position to the second position, the interlocking shaft 204, the ring gear 203, and the lifter cam 205 (see FIG. 12) pivot together with the pivoting of the handle 201. As a result, a cam surface 205a of the lifter cam 205 presses the pressed surface 184a of the connector holder 184 upward. Then, as shown in FIGS. 17A and 17B, the fixing-side connector 185 is slid upward together with the connector holder 184, and moves to a release position where the fitting to the body-side connector 223 is released. Accordingly, the electrical connection between the apparatus body 1001A and the fixing device 180 is released. At this time, since the handle 201 is located at the second position, the fixing lock member 202 is located at the release position as shown in FIG. 15B. Therefore, the fixing device 180 is removable from the apparatus body 1001A.

FIG. 18A illustrates a state in which the fixing device 180 is mounted on the apparatus body 1001A and the handle 201 is returned to the first position. At this time, when the door 20 is closed to the closed position, an inclined surface portion 23 provided on the door 20 abuts on the driven roller 187 supported by the connector inserter 186. When the door 20 is further closed toward the closed position, the inclined surface portion 23 presses the driven roller 187 downward, and the connector inserter 186 pivots counterclockwise in FIG. 18A. As a result, the elastic portion 186a provided at the lower portion of the connector inserter 186 pushes the connector holder 184 downward, and the connector holder 184 is slid downward toward the body-side connector 223.

That is, the connector inserter 186, the driven roller 187, and the inclined surface portion 23 form a moving portion 600 that positions the fixing-side connector 185 at the fitting position when the door 20 moves from the opened position to the closed position. Even when the connector inserter 186 further pivots counterclockwise after the fixing-side connector 185 attached to the connector holder 184 is fitted to the body-side connector 223, the elastic portion 186a is elastically deformed to absorb the force.

As shown in FIG. 18B, when the door 20 is located at the closed position, the inclined surface portion 23 provided on the door 20 passes through the driven roller 187 and does not come into contact with the driven roller 187. With such a configuration, the inclined surface portion 23 and the door 20 do not continuously receive forces from the connector inserter 186 and the driven roller 187, so that deformation of the door 20 can be suppressed.

As described above, in the present embodiment, the fixing lock member 202 and the fixing-side connector 185 can be moved by operating the handle 201. In other words, the interlocking unit 400 including the handle 201 is configured to be interlocked with the fixing lock member 202 and the fixing-side connector 185.

By rotating the handle 201 from the first position to the second position, the fixing-side connector 185 moves from the fitting position to the release position, and the fixing lock member 202 pivots from the restricting position to the allowing position. When the user lifts the fixing device 180 upward in a state in which the fitting between the fixing-side connector 185 and the body-side connector 223 is released, the fixing device 180 is removed from the apparatus body 1001A.

Therefore, a force for pulling out the fixing-side connector 185 from the body-side connector 223 is not required when lifting the fixing device 180. Similarly, a force for fitting the fixing-side connector 185 to the body-side connector 223 is not required when mounting the fixing device 180 on the apparatus body 1001A. Therefore, workability at the time of removing and mounting the fixing device 180 from and on the apparatus body 1001A can be improved. In other words, workability when the fixing device 180 moves from the mounting position can be improved.

In plan view, the fixing-side connector 185 is disposed at a position not overlapping with the center of gravity of the fixing-side connector 185. Therefore, in a case where insertion and removal of the fixing-side connector 185 and the body-side connector 223 are necessary when attaching and detaching the fixing device 180 to and from the apparatus body 1A, a force balance when lifting the fixing device 180 is not well balanced, which causes a decrease in workability. However, in the present embodiment, the fixing device 180 is lifted after the fixing-side connector 185 is pulled out from the body-side connector 223. Therefore, it is possible to improve the balance of the force for lifting the fixing device 180, and it is possible to improve the workability when removing the fixing device 180 from the apparatus body 1001A.

In addition, when the door 20 is closed after the fixing device 180 is mounted on the apparatus body 1001A, the connector inserter 186 moves the connector holder 184 and the fixing-side connector 185 to the fitting position. Therefore, it is possible to prevent the fixing-side connector 185 from being inserted into and removed from the body-side connector 223 in a state in which the fixing device 180 is inclined, and it is possible to reduce breakage of the fixing-side connector 185 and the body-side connector 223. In addition, since work for the fitting between the fixing-side connector 185 and the body-side connector 223 is not performed simultaneously with work for the mounting of the fixing device 180, an operation force for the user can be reduced.

In the present embodiment, the handle 201 is provided on a side of the opening portion 9 of the apparatus body 1001A, but the present technology is not limited thereto. For example, the handle 201 may be provided at another position such as a back surface of the apparatus body 1001A.

In addition, the interlocking unit 400 including the handle 201 and the fixing lock member 202 may be provided in the apparatus body 1001A instead of the fixing device 180. At this time, it is preferable that the body-side connector 223 is configured to be movable instead of the fixing-side connector 185. That is, a connector movable between the fitting position and the release position may be provided in any one of the fixing device 180 and the apparatus body 1001A, and a connector that does not move may be provided in the other one of the fixing device 180 and the apparatus body 1001A.

Further, in the present embodiment, the fixing lock member 202 is fixed to the interlocking shaft 204, and the lifter cam 205 for moving the fixing-side connector 185 is rotatably supported by the camshaft 209, but the present technology is not limited thereto. For example, the fixing lock member 202 and the lifter cam 205 may be supported by the same shaft.

### Other Embodiments

In the second embodiment, the handle 201 and the fixing lock member 202 are configured to always pivot integrally, but the present technology is not limited thereto. For example, similarly to the first embodiment, a play may be provided between the interlocking shaft 204 and the fixing lock member 202, and only the lifter cam 205 may move from the fitting position to the release position when the handle 201 pivots from the first position to the third position. When the handle 201 pivots from the third position to the second position, only the fixing lock member 202 may pivot from the restricting position to the allowing position. The third position is a position between the first position and the second position. Therefore, the fixing device 180 can be removed from the apparatus body 1001A after the fitting between the fixing-side connector 185 and the body-side connector 223 is released, and an operation force for handle 201 can be reduced.

Further, in the second embodiment, an example in which the fixing device 180 is removed upward from the apparatus body 1001A has been described, but the present technology is not limited thereto. For example, the fixing device 180 may be configured to be movable from the mounting position to an upper position above the mounting position by a link mechanism or the like, and the fixing device 180 may be supported by the apparatus body 1A at the upper position. For example, the fixing device 180 may be supported by the interlocking shaft 204 of the interlocking unit 400 at the upper position. In such a configuration, at the restricting position, the fixing lock member 202 restricts movement of the fixing device 180 from the mounting position to the upper position, and at the allowing position, the fixing lock member 202 allows the movement of the fixing device 180 from the mounting position to the upper position.

In the second embodiment, the fixing lock member 202 and the fixing-side connector 185 are configured to be moved by operating the handle 201 exposed when the door 20 is opened, but the present technology is not limited thereto. For example, the door 20 and the interlocking shaft 204 may be connected by a link mechanism, and the fixing lock member 202 and the fixing-side connector 185 may move in conjunction with an opening and closing operation of the door 20. At this time, the interlocking unit 400 moves from the first operation position to the second operation position when the door 20 moves from the closed position to the opened position.

In any of the embodiments described above, the fixing device 80 or 180 includes the heating roller 83 and the pressure roller 84, but the present technology is not limited thereto. For example, a heating unit including a heater such as a ceramic heater and a fixing film heated by the heater may be applied instead of the heating roller 83. Alternatively, a fixing belt including a heat generation layer that generates heat by electromagnetic induction heating may be applied instead of the heating roller 83.

In any of the embodiments described above, the photosensitive drum 61, the charging roller 62, and the developing roller 71 are provided in the process cartridges (PY to PK), but the present technology is not limited thereto. That is, the photosensitive drum 61, the charging roller 62, and the developing roller 71 may be provided in any one of the process cartridge and the tray 51.

In any of the embodiments described above, the door 20 is pivotable about the pivot shaft 20b, but the present technology is not limited thereto. For example, a cover slidable or removable with respect to the apparatus body 1A may be provided instead of the door 20.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-039390, filed Mar. 13, 2024, which is hereby incorporated by reference herein in its entirety.

What is claimed is:

1. An image forming apparatus configured to form an image on a sheet, the image forming apparatus comprising:
an apparatus body;
a mounting unit mounted on the apparatus body at a mounting position;
a restricting portion configured to move to a restricting position where the restricting portion restricts a movement of the mounting unit from the mounting position, and to an allowing position where the restricting portion allows the movement of the mounting unit from the mounting position;
a first connector provided in either one of the apparatus body and the mounting unit;
a second connector provided in the other of the apparatus body and the mounting unit and configured to move between a fitting position where the second connector is fitted to the first connector to electrically connect the apparatus body to the mounting unit and a release position where fitting of the second connector to the first connector is released; and
an interlocking portion configured to move between a first operation position and a second operation position and configured to be interlocked with the restricting portion and the second connector, the interlocking portion moving from the first operation position to the second operation position so that the restricting portion moves from the restricting position to the allowing position and the second connector moves from the fitting position to the release position,
wherein the interlocking portion includes an operation portion, a pivot shaft configured to pivot integrally with the operation portion and configured to pivotably support the restricting portion, and a cam pivotably supported by the pivot shaft and configured to move the second connector from the fitting position to the release position.

2. The image forming apparatus according to claim 1, wherein the mounting unit is a fixing device configured to fix a toner image to the sheet by applying heat and pressure to the sheet.

3. The image forming apparatus according to claim 1, wherein the mounting unit is a stacking device on which the sheet to be fed toward the apparatus body is stacked.

4. The image forming apparatus according to claim 3, wherein the stacking device is disposed below the apparatus body, and
the second connector is provided in the apparatus body and is slid upward in a case of moving from the fitting position toward the release position.

5. The image forming apparatus according to claim 3, wherein the restricting portion is provided in the apparatus body and restricts the movement of the mounting unit from the mounting position by being engaged with the mounting unit at the restricting position.

6. The image forming apparatus according to claim 3, wherein the interlocking portion is configured to move from the second operation position to the first operation position so that the restricting portion moves from the allowing position to the restricting position and the second connector moves from the release position to the fitting position.

7. The image forming apparatus according to claim 3, further comprising: a locking portion configured to lock the interlocking portion at the second operation position.

8. The image forming apparatus according to claim 3, wherein the interlocking portion is configured to move to a third operation position between the first operation position and the second operation position,
in a case where the interlocking portion is located at the third operation position, the restricting portion is located at the restricting position, and the second connector is located at the release position, and
the interlocking portion moves the second connector from the fitting position to the release position by moving from the first operation position to the third operation position, and moves the restricting portion from the restricting position to the allowing position by moving from the third operation position to the second operation position.

9. The image forming apparatus according to claim 3, further comprising an actuator configured to move the interlocking portion from the first operation position to the second operation position.

10. The image forming apparatus according to claim 1, wherein the second connector is disposed at a position not overlapping with a center of gravity of the mounting unit in plan view.

11. An image forming apparatus configured to form an image on a sheet, the image forming apparatus comprising:
an apparatus body;
a mounting unit mounted on the apparatus body at a mounting position;
a restricting portion configured to move to a restricting position where the restricting portion restricts a movement of the mounting unit from the mounting position, and to an allowing position where the restricting portion allows the movement of the mounting unit from the mounting position;
a first connector provided in either one of the apparatus body and the mounting unit;
a second connector provided in the other of the apparatus body and the mounting unit and configured to move between a fitting position where the second connector is fitted to the first connector to electrically connect the apparatus body to the mounting unit and a release position where fitting of the second connector to the first connector is released; and
an interlocking portion configured to move between a first operation position and a second operation position and configured to be interlocked with the restricting portion and the second connector, the interlocking portion moving from the first operation position to the second operation position so that the restricting portion moves from the restricting position to the allowing position and the second connector moves from the fitting position to the release position,
wherein the mounting unit is a fixing device configured to fix a toner image to the sheet by applying heat and pressure to the sheet.

12. The image forming apparatus according to claim 11, further comprising an opening and closing member openably and closably supported with respect to the apparatus body between a closed position where the opening and closing member covers an opening portion of the apparatus body and an opened position where the opening and closing member opens the opening portion,
wherein the fixing device is configured to be movable upward from the mounting position toward the opening portion in a case where the restricting portion is located at the allowing position.

13. The image forming apparatus according to claim 12, wherein the second connector is provided in the fixing device and is slid upward in a case of moving from the fitting position toward the release position.

14. The image forming apparatus according to claim 12, wherein the interlocking portion includes an operation portion exposed from the opening portion in a case where the opening and closing member is located at the opened position, and is configured to move between the first operation position and the second operation position in a case where the operation portion is operated.

15. The image forming apparatus according to claim 12, wherein the interlocking portion moves the restricting portion from the allowing position to the restricting position by moving from the second operation position to the first operation position, and
the image forming apparatus further comprises a moving portion moves the second connector to the fitting position in a case where the opening and closing member moves from the opened position to the closed position.

16. The image forming apparatus according to claim 12, wherein the interlocking portion moves from the first operation position to the second operation position in a case where the opening and closing member moves from the closed position to the opened position.

17. The image forming apparatus according to claim 12, further comprising an image forming portion configured to form the toner image on the sheet,
wherein the interlocking portion is configured to be retractable so as not to interfere with a movement locus of the image forming portion in a case where the image forming portion is moved toward the opening portion.

18. The image forming apparatus according to claim 11, wherein the restricting portion is provided in the fixing device and restricts a movement of the fixing device from the mounting position by being engaged with the apparatus body at the restricting position.
